(19) United States
(12) Patent Application Publication
(10) Pub. No.: US 2023/0266541 A1
(43) Pub. Date: Aug. 24, 2023

(54) SURFACE MOUNT MODULE FOR POWER FIBER CABLE

(71) Applicant: CommScope Technologies LLC, Hickory, NC (US)

(72) Inventors: Timothy W. ANDERSON, Omaha, NE (US); Scott Martin KEITH, Plano, TX (US); Jeffrey Allan OBERSKI, Lucas, TX (US)

(21) Appl. No.: 18/309,321

(22) Filed: Apr. 28, 2023

Related U.S. Application Data
(63) Continuation of application No. PCT/US2021/056271, filed on Oct. 22, 2021.
(60) Provisional application No. 63/107,529, filed on Oct. 30, 2020.

(51) Int. Cl. G02B 6/38; G02B 6/44

(52) U.S. Cl. CPC G02B 6/3897; G02B 6/4448; G02B 6/4452

(57) ABSTRACT

A surface mount module distributes electrical power and fiber optic data connectivity from a power fiber cable. The surface mount module includes at least one port configured to provide fiber optic data connectivity with optical fibers that break out from the power fiber cable. The surface mount module further includes at least one port configured to distribute electrical power from electrical power wires of the power fiber cable. A power adapter is configured for fixation to the at least one port configured to distribute electrical power, and the power adapter is configured to receive an internal power connector at an interior side and to receive an external power connector at an exterior side.

### CROSS-REFERENCE TO RELATED APPLICATIONS

This application is a Continuation of International Patent Application No. PCT/US2021/056271, filed on Oct. 22, 2021, which claims the benefit of U.S. patent application Ser. No. 63/107,529, filed on Oct. 30, 2020, the disclosures of which are incorporated herein by reference in their entireties. To the extent appropriate, a claim of priority is made to each of the above disclosed applications.

### BACKGROUND

Certain devices utilize cables to provide power to the device and to carry data to and from the device. As the data gathering capacity of these devices has increased, greater demand for bandwidth to carry data to and from the devices has arisen. One way of providing this increased bandwidth is to use optical fiber for carrying data to and from the devices.

Optical fiber does not provide an adequate power supply for the devices, so it can still be desirable to have copper or other metallic wires extending to the devices. Hybrid cables including both copper wires and optical fiber within a single cable have been used to meet the power and data transfer needs of devices. The techniques and devices for terminating and connectorizing copper wires and optical fiber are different.

### SUMMARY

In general terms, the present disclosure relates to distributing electrical power and fiber optic data connectivity from a power fiber cable. In one possible configuration, a module includes one or more ports to distribute electrical power from the power fiber cable and one or more ports to distribute fiber optic connectivity from the power fiber cable. Various aspects are described in this disclosure, which include, but are not limited to, the following aspects.

One aspect relates to a surface mount module for distributing electrical power and fiber optic data connectivity from a power fiber cable. The surface mount module comprises a base having one or more features for attaching the surface mount module to a surface; a cover attachable to the base to define an interior space inside the surface mount module, the interior space including one or more wire management devices for routing electrical power wires and optical fibers that break out from the power fiber cable; at least one port configured to provide fiber optic data connectivity with the optical fibers that break out from the power fiber cable; at least one port configured to distribute electrical power from the electrical power wires of the power fiber cable; and a power adapter configured for fixation to the at least one port configured to distribute electrical power, and being further configured to receive an internal power connector at an interior side and to receive an external power connector at an exterior side.

Another aspect relates to a power adapter for a surface mount module. The power adapter comprises first and second sets of catch features positioned on opposite sides of the power adapter, each of the first and second sets of catch features including: one or more distal catch features with angled surfaces; one or more proximal catch features; and a groove defined between the distal catch features and the proximal catch features, the groove configured to catch onto a wall that at least partially defines a port; and flexible arms each having a latch at a terminal end, the latches being configured to fix an internal power connector to an interior side of the power adapter before the power adapter is installed into the port, or after the power adapter is installed into the port, and wherein the power adapter is structured to receive an external power connector at an exterior side.

Another aspect relates to a method of assembling a port for distributing electrical power from a surface mount module. The method comprises aligning a power adapter with an appropriate port of the surface mount module; fixing the power adapter to the port by: partially inserting the power adapter into the port at an angle; capturing a top portion of a wall where the port is located into a groove defined between a first set of catch features; and pivoting an interior side of the power adapter until a groove defined between a second set of catch features captures a bottom portion of the wall where the port is located; and inserting an internal power connector into the interior side of the power adapter.

### DESCRIPTION OF THE FIGURES

The following drawing figures, which form a part of this application, are illustrative of the described technology and are not meant to limit the scope of the disclosure in any manner.

FIG. 1 is a top isometric view of a surface mount module.

FIG. 2 is a bottom isometric view of the surface mount module.

FIG. 3 is a front view of the surface mount module.

FIG. 4 is a rear view of the surface mount module.

FIG. 5 is a right side view of the surface mount module.

FIG. 6 is a left side view of the surface mount module.

FIG. 7 is a top view of the surface mount module.

FIG. 8 is a bottom view of the surface mount module.

FIG. 9 is an exploded, isometric view of the surface mount module.

FIG. 10 is a cross-sectional view of a fiber optic adapter partially inserted into a port of the surface mount module of FIGS. 1-9.

FIG. 11 is a cross-sectional view of the fiber optic adapter of FIG. 10 fully inserted into the port of the surface mount module of FIGS. 1-9.

FIG. 12 is a front, top isometric view of a power adapter adapted for insertion into a port of the surface mount module of FIGS. 1-9.

FIG. 13 is a rear, bottom isometric view of the power adapter of FIG. 12.

FIG. 14 is a front, isometric view of an internal power connector.

FIG. 15 is an isometric view of the internal power connector of FIG. 14 and the power adapter of FIG. 12 before the internal power connector is inserted into the power adapter.

FIG. 16 is an isometric view of the internal power connector of FIG. 14 inserted into the power adapter of FIG. 12.

FIG. 17 is a cross-sectional view of the assembly of the power adapter and internal power connector of FIG. 16 partially inserted into a port of the surface mount module.

FIG. 18 is a cross-sectional view of the assembly of the power adapter and internal power connector of FIG. 16 fully inserted into a port of the surface mount module.

FIG. 19 is a rear, isometric view of an external power connector.

FIG. 20 is a cross-sectional view of the external power connector of FIG. 19 inserted into the power adapter of FIG. 12, the power adapter inserted into a port of the surface mount module, and the internal power connector of FIG. 14 inserted into the power adapter.

FIG. 21 is a top isometric view of a portion of the surface mount module of FIGS. 1-9 with a cover removed therefrom, exposing the external power connector of FIG. 19 inserted into the power adapter of FIG. 12, the power adapter inserted into a port of the surface mount module, and the internal power connector of FIG. 14 inserted into the power adapter.

FIG. 22 is another cross-sectional view of the external power connector of FIG. 19 inserted into the power adapter of FIG. 12, the power adapter inserted into a port of the surface mount module, and the internal power connector of FIG. 14 inserted into the power adapter.

FIG. 23 is a top, front isometric view of another embodiment of the surface mount module, the surface mount module including one fiber optic adapter and one power adapter each inserted into a respective port of the surface mount module.

FIG. 24 shows an assembly of electrical power wires routed from a power fiber cable into the internal power connector of FIG. 14.

FIG. 25 shows electrical power wires terminated by the external power connector of FIG. 19, and before the external power connector is inserted into the power adapter.

FIG. 26 shows a breakout of electrical power wires and optical fibers from a power fiber cable inside the surface mount module of FIGS. 1-9.

FIG. 27 is a view of the power adapter of FIG. 12 being removed from a port of the surface mount module of FIGS. 1-9.

FIG. 28 is another view of the power adapter of FIG. 12 being removed from a port of the surface mount module of FIGS. 1-9.

FIG. 29 illustrates a method of assembling a port for distributing electrical power from the surface mount module of FIGS. 1-9.

FIG. 30 illustrates in more detail an operation from the method of FIG. 29 of fixing the power adapter of FIG. 12 to a port of the surface mount module of FIGS. 1-9.

FIG. 31 illustrates in more detail an operation from the method of FIG. 29 of attaching electrical power wires from a power fiber cable to positive and negative polarity terminals of the internal power connector of FIG. 14.

FIG. 32 shows an example location for mounting the surface mount module.

FIG. 33 shows an example of a base of one embodiment of the surface mount module mounted to the example location of FIG. 32.

FIG. 34 shows an example of a base of another embodiment of the surface mount module mounted to the example location of FIG. 32.

FIG. 35 shows a cover attached to the base of the surface mount module of FIG. 33 and with an external power connector and a fiber connector each installed in a power adapter and a fiber optic adapter, respectively.

FIG. 36 shows a cover attached to the base of the surface mount module of FIG. 34 and with external power connectors and fiber optic connectors installed in respective power adapters and fiber optic adapters.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

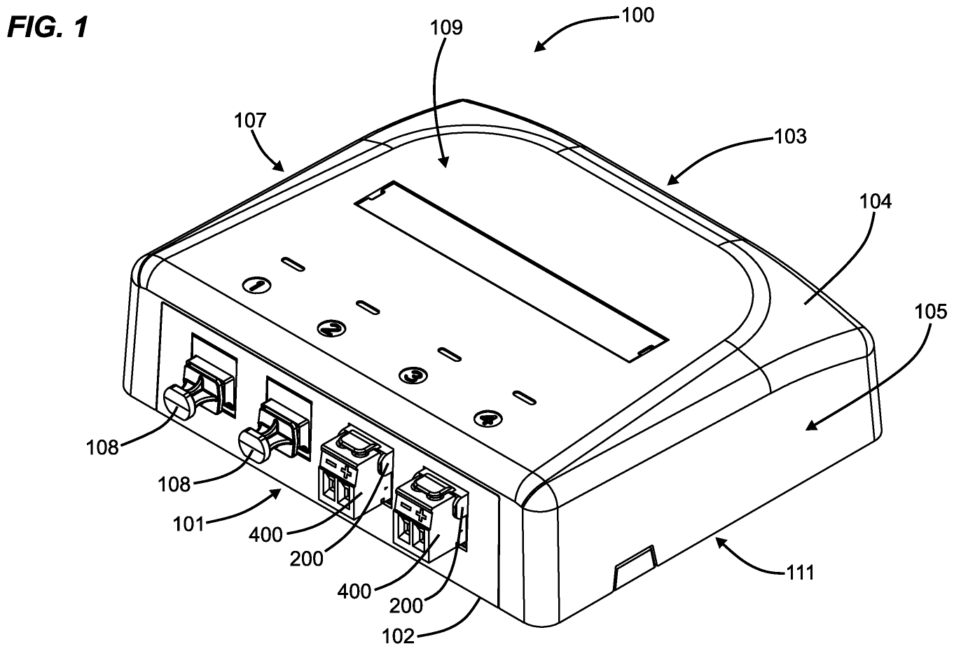

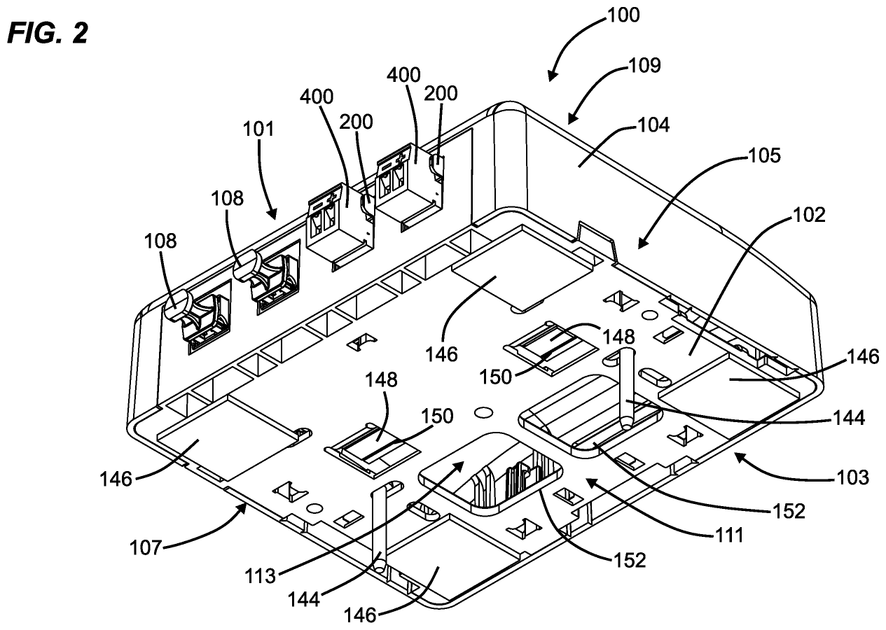

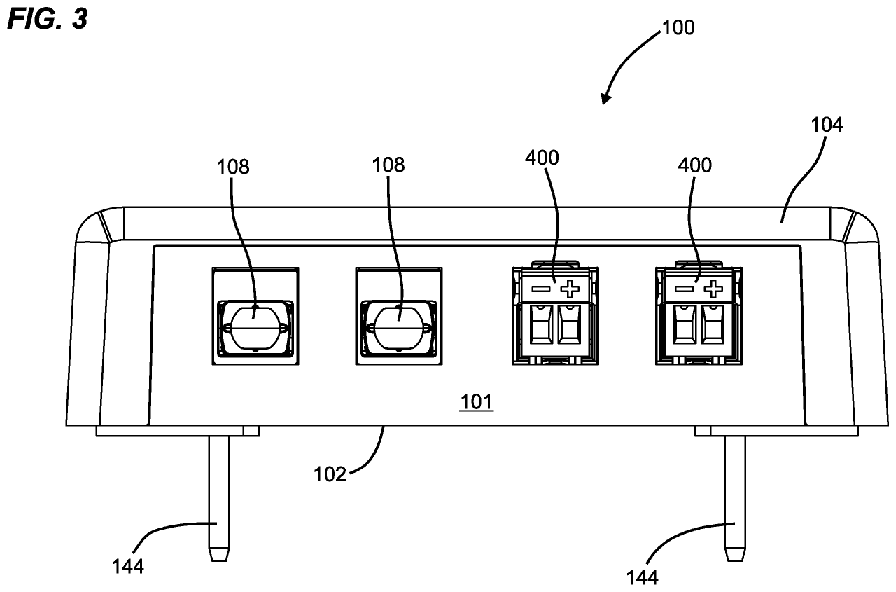

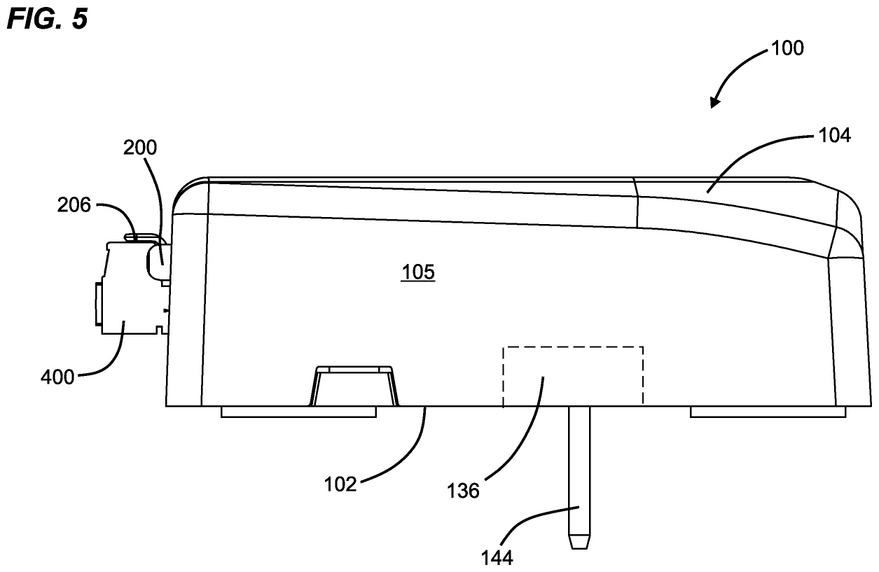

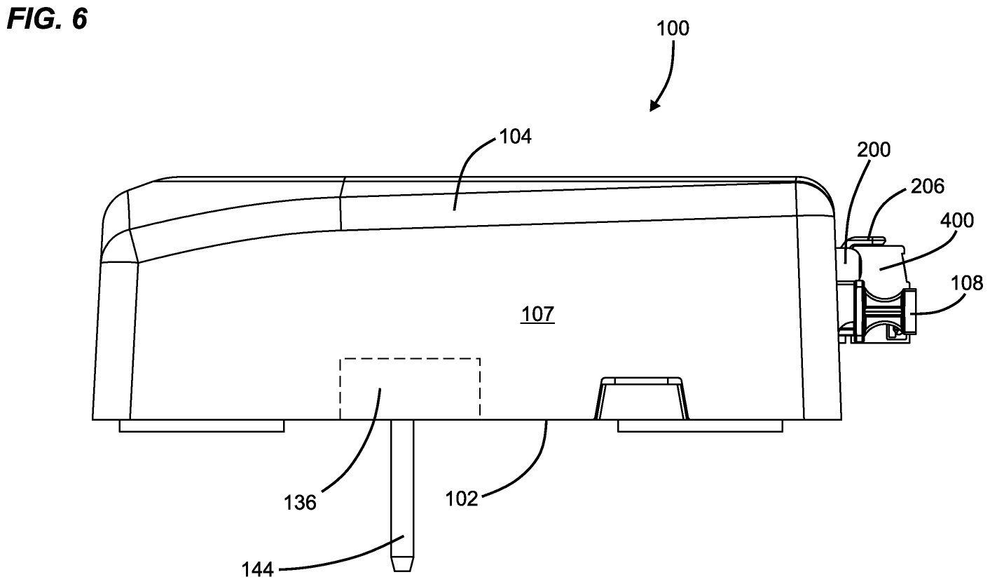

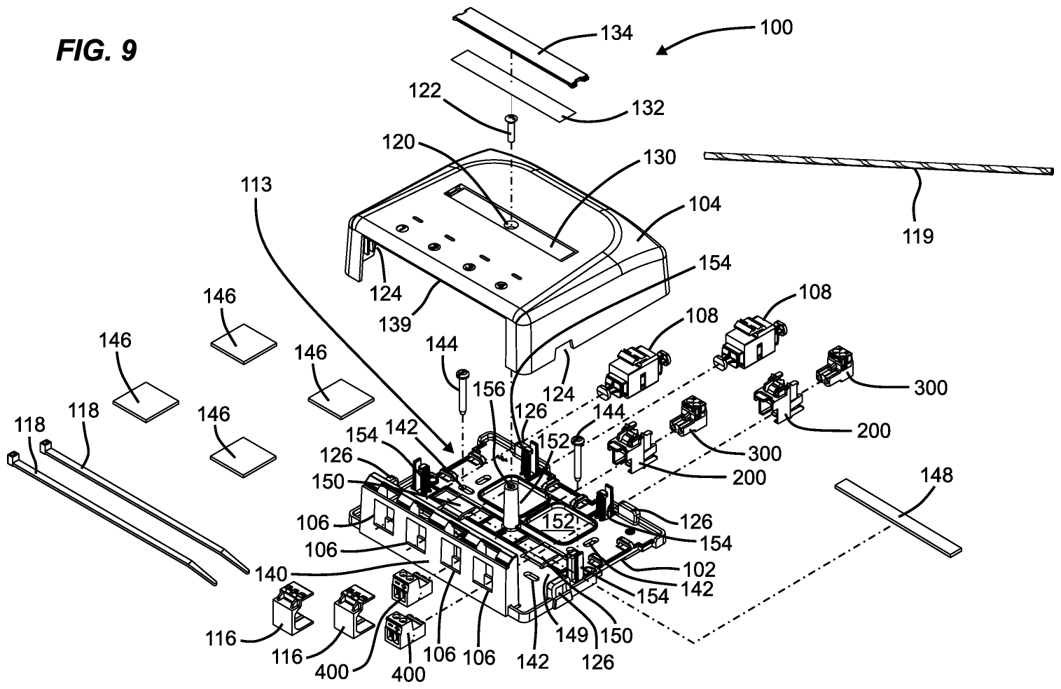

FIGS. 1-8 provide top isometric, bottom isometric, front, rear, right side, left side, top, and bottom views of a surface mount module 100. FIG. 9 is an exploded view of the surface mount module 100. Referring now to FIGS. 1-9, the surface mount module 100 includes a front 101, a rear 103, a right side 105, a left side 107, a top 109, and a bottom 111. Throughout this disclosure, references to orientation (e.g., front(ward), rear(ward), in front, behind, above, below, high, low, back, top, bottom, under, underside, etc.) of structural components shall be defined by the position of that component relative to the front 101, rear 103, right side 105, left side 107, top 109, and/or bottom 111 of the surface mount module 100, regardless of how the surface mount module 100 may be held and/or installed on a surface, and regardless of how that component may be situated on its own (e.g., separated from the surface mount module 100).

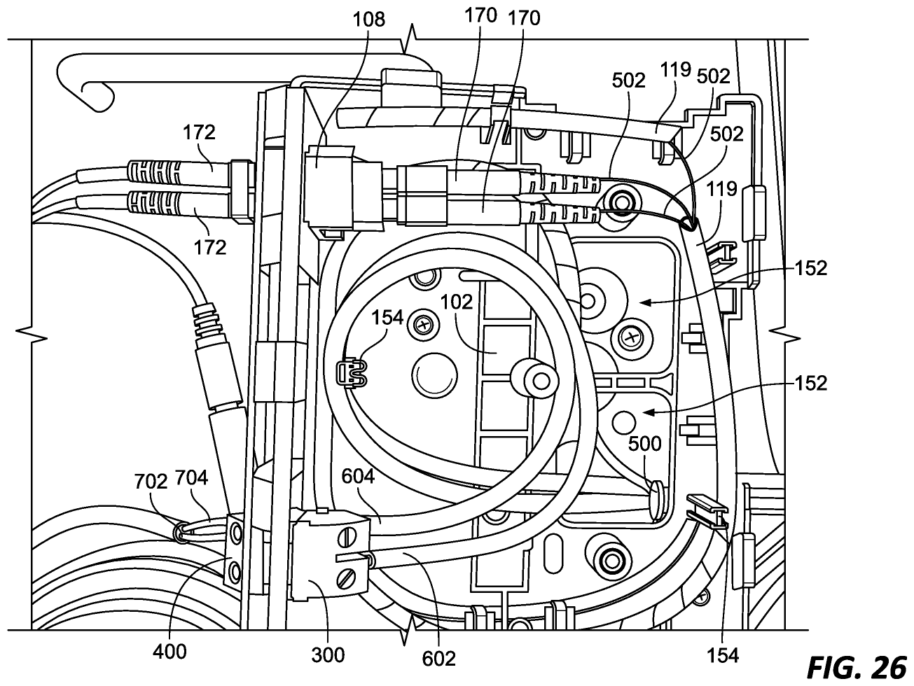

As shown in the exploded view of FIG. 9, the surface mount module 100 includes a base 102, and a cover 104 that attaches to the base 102 to define an interior space 113 inside the surface mount module. The interior space 113 inside the surface mount module 100 is structured to receive a power fiber cable 500 (see FIG. 26). The power fiber cable 500 breaks out into copper wires and optical fibers that are routed and organized within the interior space 113.

The base 102 defines a plurality of ports 106. As will be described in more detail, at least one port 106 is dedicated for distributing fiber optic connectivity and at least one port 106 is dedicated for distributing electrical power from the surface mount module 100. In some examples, the ports 106 are substantially identical, and can receive either a fiber optic adapter 108, a power adapter 200, or a blank inserts 116 that will be described in more detail below.

The base 102 includes the exterior wall 140 that defines the ports 106. The exterior wall 140 extends orthogonally from the base 102. An opening 139 on the cover 104 abuts the lateral and top portions of the exterior wall 140 when the cover 104 is attached to the base 102. The base 102 and cover 104 can both be made from a polycarbonate plastic material.

In the example embodiment of FIGS. 1-8, the surface mount module 100 includes two ports 106 that are each dedicated for distributing fiber optic connectivity and two ports 106 that are each dedicated for distributing electrical power. The number of ports 106 may vary such that the surface mount module 100 can have fewer than four ports, or more than four ports.

The surface mount module 100 includes at least one fiber optic adapter 108 inserted into a port 106 defined by the base 102. The fiber optic adapter 108 is adapted to terminate an optical fiber routed from the power fiber cable 500 (see FIG. 26) inside the surface mount module 100. In some examples, one, two, or more man than two fibers are broken out from the power fiber cable 500 such that the fiber optic adapter 108 can distribute one, two, or more than two fiber connections. In certain examples, the fiber optic adapter 108 is an LC duplex adapter.

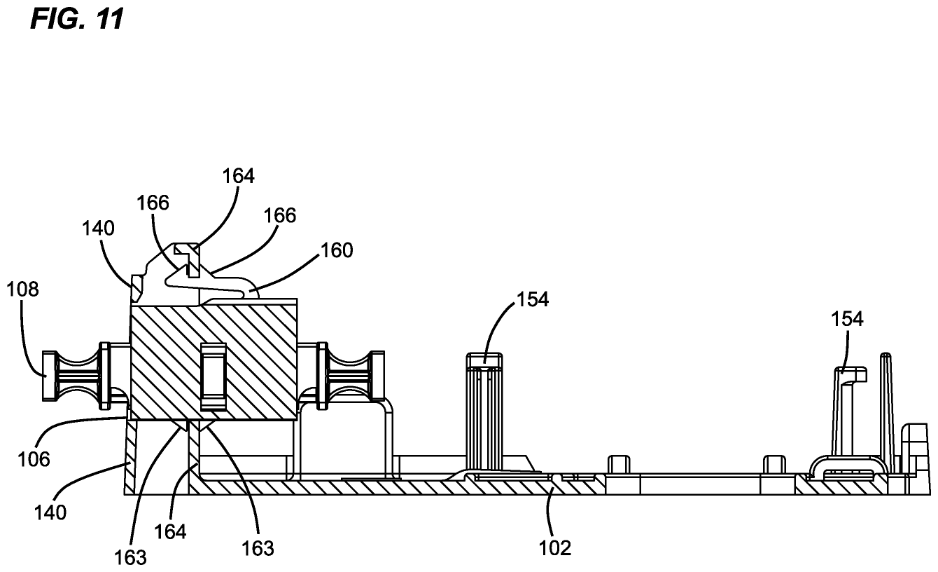

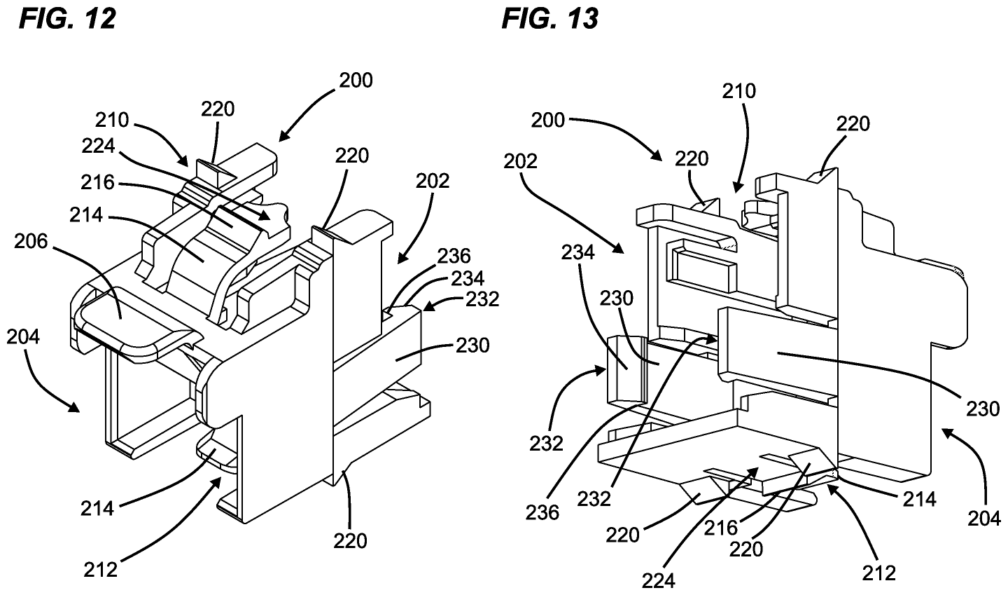

The surface mount module 100 further includes at least one power adapter 200 inserted into a port 106 defined by the base 102. The power adapter 200 is structured to receive an internal power connector 300 at an interior side and to receive an external power connector 400 at an exterior side. The internal power connector 300 is structured to terminate an electrical power wire routed from the power fiber cable 500 (see FIG. 26) inside the surface mount module 100. The external power connector 400 is structured to terminate an electrical power wire routed from an external device such as a modem, router, cable television set-top box, and the like. The power adapter 200 will be described in more detail with reference to FIGS. 12 and 13.

The surface mount module 100 can include the base 102, cover 104, fiber optic adapter 108, power adapter 200, internal power connector 300, and external power connector 400 as a disassembled kit of loose parts that is configured for assembly in the field during installation of the surface mount module 100. In certain examples, the copper wires and optical fibers from the power fiber cable 500 are connectorized, and the at least one fiber optic adapter 108, power adapter 200, and internal power connector 300 are installed and tested by a construction installer. Following construction, the surface mount module 100 can be hooked up to equipment via the external power connector 400 that is installed by a separate operations/equipment installer (i.e., IT hardware staff). Also, in some examples, the surface mount module 100 can include only the power adapter 200, internal power connector 300, and external power connector 400 such that the fiber optic adapter 108 is optional, and is not included in the kit of loose parts.

In certain examples, the surface mount module 100 is provided with one or more cable ties 118 to help organize the power fiber cable 500 (see FIG. 26) inside the interior space of the surface mount module 100. Additionally, the surface mount module 100 can be provided with one or more spiral wraps 119 to protect the portions of the optical fibers that are broken out from the power fiber cable 500 inside the interior space 113 of the surface mount module 100.

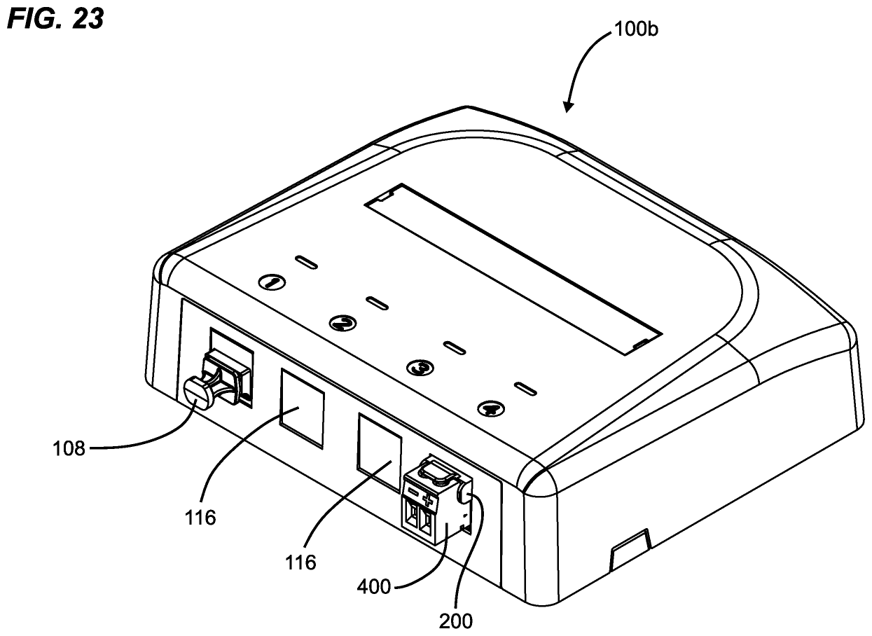

Additionally, the surface mount module 100 may include one or more blank inserts 116 that can be used to cover and block access to a port 106 that is not being used to distribute electrical power or fiber optic connectivity from the power fiber cable 500 (i.e., a port that does not include a fiber optic adapter 108 or power adapter 200 inserted therein). For example, FIG. 23 provides an isometric view of another embodiment of a surface mount module 100b that includes one fiber optic adapter 108 and one power adapter 200 (with external power connector 400 inserted therein) inserted into a respective port 106, and two blank inserts 116 covering the remaining ports 106 of the surface mount module 100.

Still referring to FIG. 9, the cover 104 may include an aperture 120 that receives a cover mounting screw 122. The cover mounting screw 122 is threaded into a corresponding aperture 156 that projects from the base 102 for securing the cover 104 to the base 102.

Alternatively, or in combination with the cover mounting screw 122, the cover 104 includes one or more snap fit locations 124 that correspond to one or more snap fit locations 126 on the base 102 for attaching the cover 104 to the base 102. In certain embodiments, the snap fit locations 124 are latches or protrusions that extend from an interior surface of the cover 104, and that snap fit onto corresponding surfaces of the snap fit locations 126 on the base 102.

The cover 104 includes a label holder 130 that receives a label 132 for marking and/or identifying the surface mount module 100. The cover 104 also includes a label cover 134 that is also received by the label holder 130 for covering and thereby protecting the label 132 from dirt, dust, scratches, and the like. The label cover 134 is made from a transparent material such that the label 132 can be viewed when covered by the label cover 134.

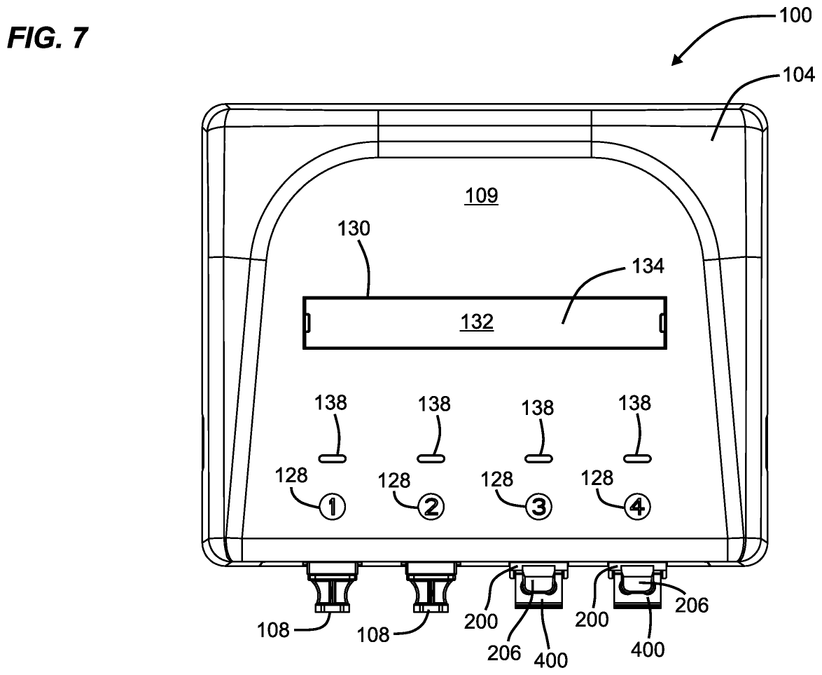

As shown in FIG. 7, the cover 104 further includes identifiers such as icon holders 138 and port identification numbers 128 that can be used to categorize and identify each port 106, respectively. For example, the icon holders 138 can be used to identify a port as providing fiber optic data connectivity, or alternatively, as distributing electrical power.

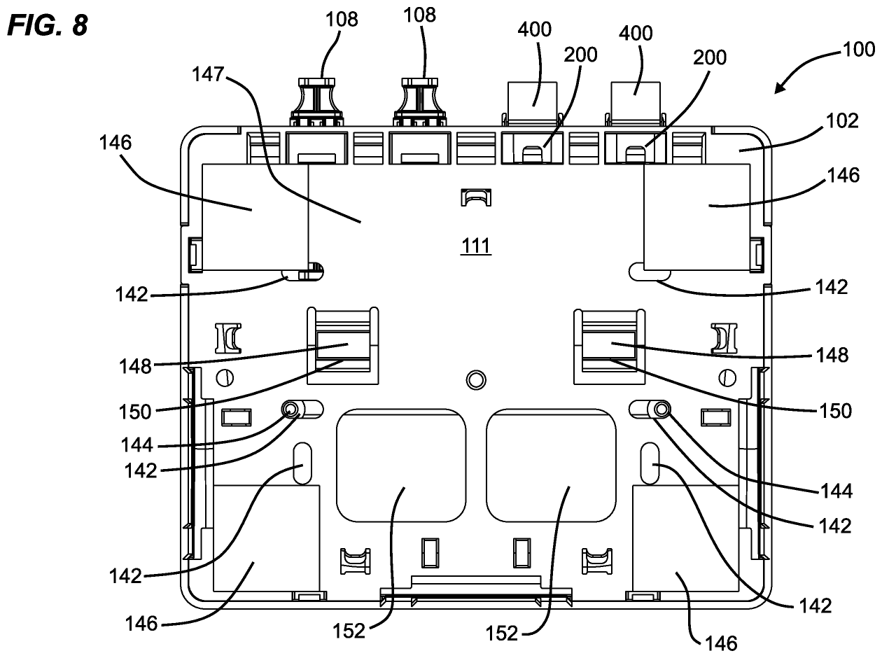

Referring now to FIGS. 8 and 9, the base 102 includes mounting holes 142 that can each receive a self-tapping screw 144 for attaching the surface mount module 100 to a surface or module such as an electrical box that is mounted to drywall in a room of a building. For example, the base 102 can be mounted to single gang and double gang NEMA electrical boxes by using the self-tapping screws 144.

Alternatively, or in addition to using the self-tapping screw 144, the base 102 can also include pieces of double-sided adhesive foam tape 146 that can be fixed on one side to the base 102, and that can fixed on an opposite side to a flat surface such as drywall in a room of a building. In the embodiment illustrated in the figures, four pieces of double-sided adhesive foam tape 146 are attached to each corner of a bottom surface 147 of the base 102. Installation of the surface mount module 100 using the pieces of double-sided adhesive foam tape 146 includes removing a protective adhesive paper from one side of a piece of double-sided adhesive foam tape 146 and placing the foam tape on the bottom surface 147 of the base 102, and repeating this step for all four pieces of foam tape. Thereafter, the installation includes removing a protective adhesive paper from the opposite side of each piece of foam tape, and pressing the base 102 up against the flat surface for securing the surface mount module 100 to the flat surface.

The base 102 can include one or more magnets 148 that are insertable in a magnet holder 150 on a top surface 149 of the base 102 for attaching the surface mount module 100 to a flat ferromagnetic surface. The magnets 148 can be used in addition to, or as an alternative to using the self-tapping screw 144 and pieces of double-sided adhesive foam tape 146.

The base 102 includes one or more openings 152 that provide access to the interior space 113 inside the surface mount module 100. The openings 152 can each provide a through-wall cable entrance for the power fiber cable 500. In the example embodiment depicted in the figures, the base 102 includes two openings 152 on the bottom surface 147.

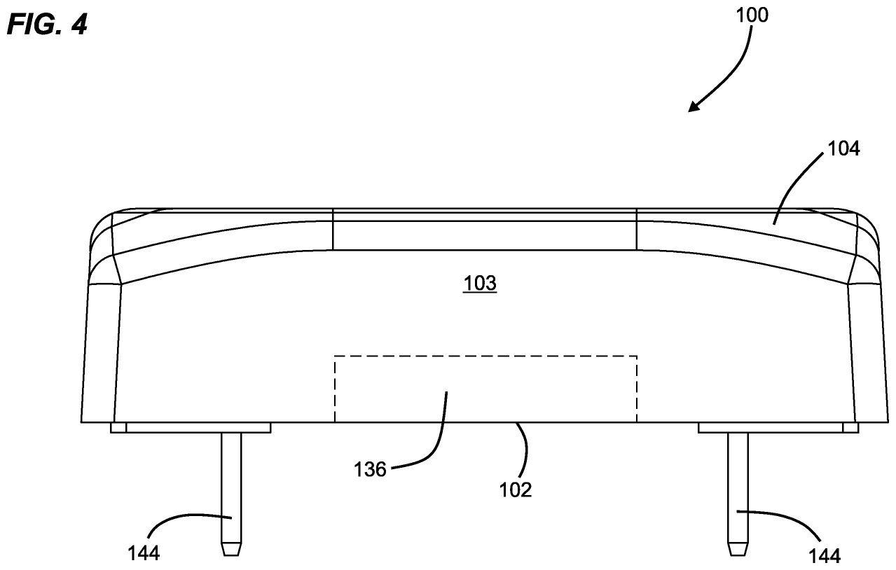

As shown in FIGS. 4-6, the cover 104 can include one or more break-out locations 136 that when opened, provide side access to the interior space 113 inside the surface mount module 100. The break-out locations 136 when opened can each provide a raceway cable entrance for the power fiber cable 500. In certain embodiments, the cover 104 includes three break-out locations 136 on the rear 103, right side 105, and left side 107.

The base 102 further includes a plurality of wire management devices 154 to help guide and route the electrical power wires and optical fibers from the power fiber cable 500 inside the interior space 113 of the surface mount module 100. The wire management devices 154 can help prevent sharp turn radiuses for the power wires and optical fibers.

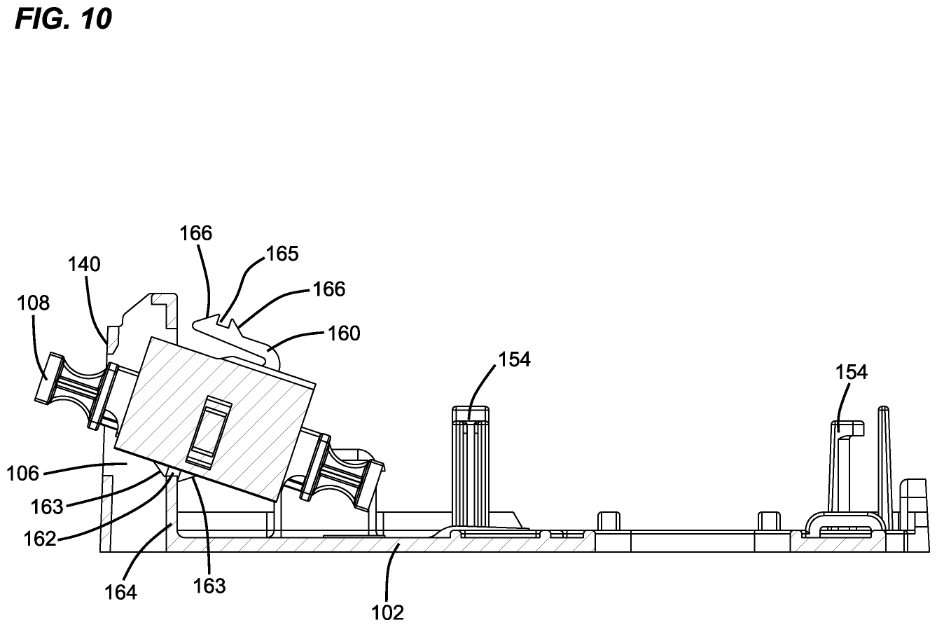

FIG. 10 is a cross-sectional view of a fiber optic adapter 108 partially inserted into a port 106 of the surface mount module 100. FIG. 11 is a cross-sectional view of the fiber optic adapter 108 fully inserted into the port 106 of the surface mount module 100. Referring now to FIGS. 10 and 11, the fiber optic adapter 108 is inserted from an interior side of the base 102 by aligning the fiber optic adapter 108 with an appropriate port of the base 102 while making sure that a movable latch 160 of the fiber optic adapter 108 is facing upward.

As shown in FIG. 10, the fiber optic adapter 108 is inserted into the port 106 at an angle such that a groove 162 engages a bottom portion of an interior wall 164 of the base 102 where the port 106 is located. Angled surfaces 163 on opposite sides of the groove 162 can help provide the capturing of the interior wall 164 in the groove 162.

Thereafter, an interior portion of the fiber optic adapter 108 is rotated upwards until a groove 165 of the movable latch 160 catches onto a top portion of the interior wall 164 of the base 102 where the port 106 is located. An angled surface 166 on the movable latch 160 helps the groove 165 catch onto the interior wall 164 as the fiber optic adapter 108 is rotated upwards. In certain examples, the connection between the groove 165 and the interior wall 164 is a snap-fit connection. The snap-fit connection allows the fiber optic adapter 108 to attach to the port 106 and to be removed from the port 106 without requiring the use of any tools.

In embodiments where the surface mount module 100 includes two ports 106 that are dedicated for distributing fiber optic connectivity, these steps can be repeated for installing a second fiber optic adapter 108. In embodiments where the surface mount module 100 includes only one port 106 dedicated for distributing fiber optic connectivity, a blank insert 116 can be inserted into an unused port for covering and blocking access to the unused port.

FIGS. 12 and 13 are isometric views of the power adapter 200. Referring now to FIGS. 12 and 13, the power adapter 200 includes an interior side 202 and an exterior side 204. When inserted into a port 106 of the surface mount module 100, the interior side 202 is positioned inside the interior space 113, while the exterior side 204 is positioned outside.

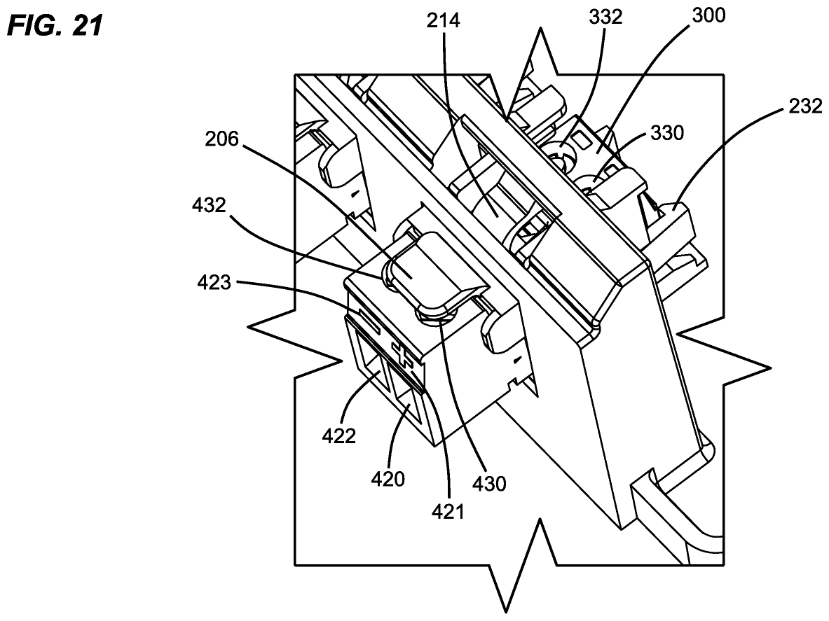

A terminal cover 206 extends outwardly from the exterior side 204. As shown in FIG. 21, the terminal cover 206 covers the screw terminals 430, 432 of the external power connector 400 when the external power connector 400 is inserted into the power adapter 200.

The power adapter 200 includes a first set of catch features 210 and a second set of catch features 212. The first and second sets of catch features 210, 212 are positioned on opposite sides of the power adapter 200. In the example embodiment depicted in the figures, the first set of catch features 210 are positioned on a top surface of the power adapter 200, and the second set of catch features 212 are positioned on a bottom surface of the power adapter 200.

Each of the first and second sets of catch features 210, 212 includes one or more distal catch features 214 with angled surfaces 216, and one or more proximal catch features 220. For each of the first and second sets of catch features 210, 212, the distal catch features 214 together with the proximal catch features 220 define a groove 224 that catches onto the interior wall 164 of the base 102 for fixing the power adapter 200 to a port 106. In certain examples, the fixation between the power adapter 200 and the interior wall 164 is a snap-fit connection that can be released to remove the power adapter 200 from the port 106.

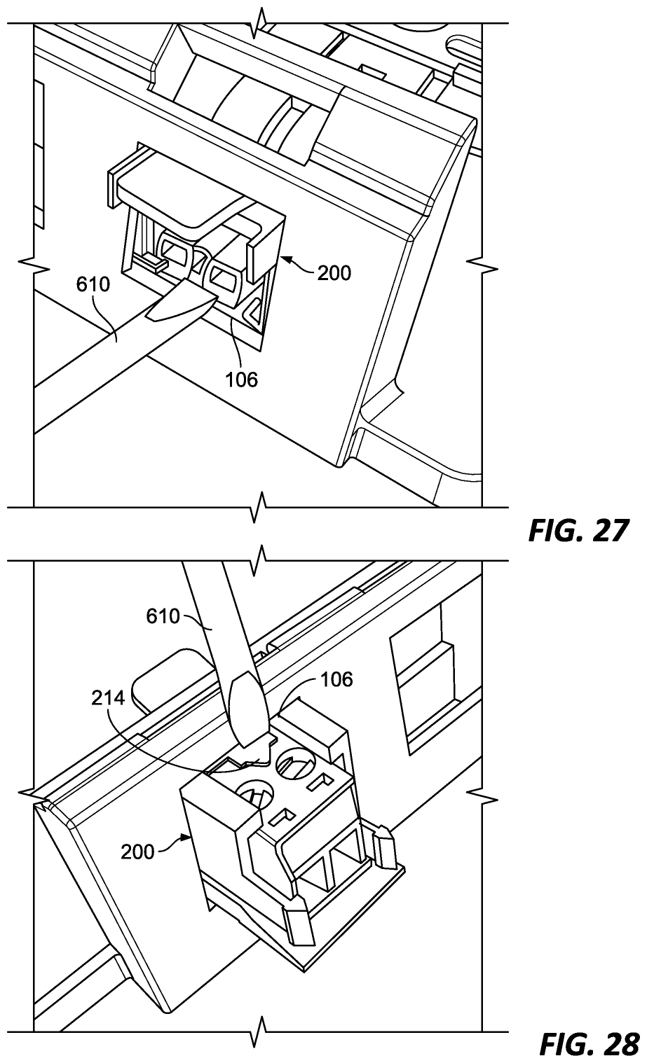

In certain embodiments, the distal catch features 214 are movable latches that flex when the angled surfaces 216 engage against the interior wall 164 when the power adapter 200 is pushed into the port 106 to provide a snap-fit connection onto the interior wall 164. In certain embodiments, the proximal catch features 220 are fixed protrusions such that the interior wall 164 remains captured by the groove 224 unless the distal catch features 214 are actuated by a screwdriver to flex inwardly to release the power adapter 200 from the port 106. The removal of the power adapter 200 from the port 106 will be described with reference to FIGS. 27 and 28.

Still referring to FIGS. 12 and 13, the power adapter 200 further includes a pair of arms 230 that each include a latch 232 at a terminal end thereof. Each latch 232 has an angled surface 234 and an orthogonal surface 236. The latches 232 are structured to fix the internal power connector 300 to the power adapter 200, as will be described in more detail.

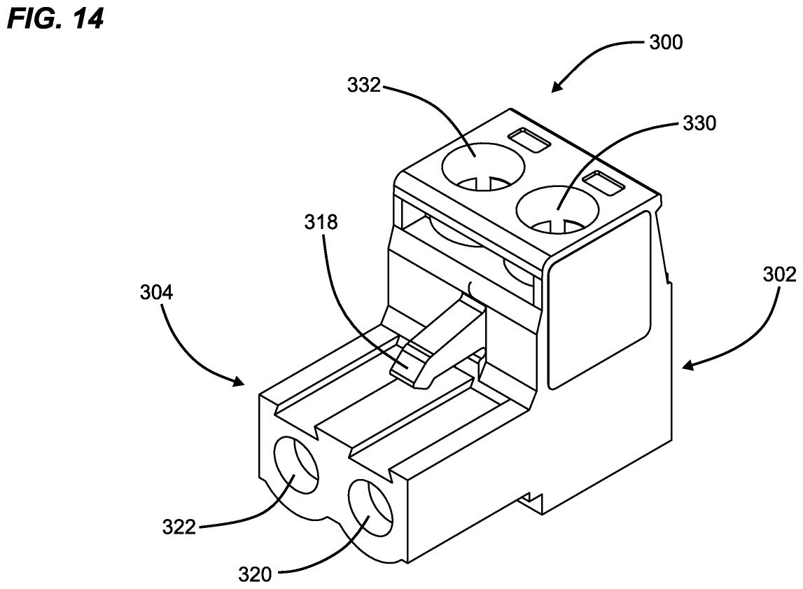

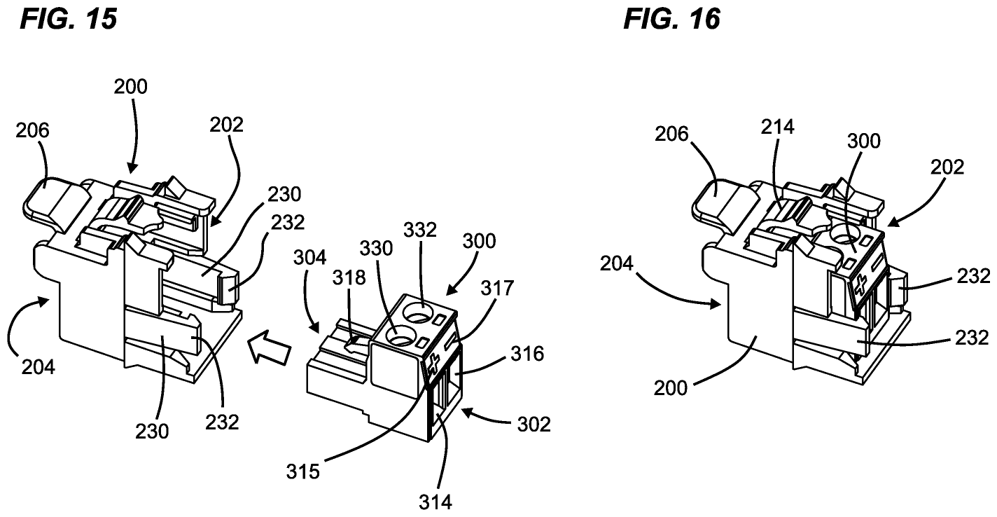

FIG. 14 is an isometric view of the internal power connector 300. FIG. 15 is an isometric view of the internal power connector 300 and power adapter 200 before the internal power connector 300 is inserted into the power adapter 200. Referring now to FIGS. 14 and 15, the internal power connector 300 includes a proximal end 302 and a distal end 304. The internal power connector 300 includes a latch 318 that extends toward the distal end 304. The latch 318 is configured to latch onto the proximal end 402 of the external power connector 400.

The proximal end 302 includes positive and negative polarity terminals 314, 316 that receive the electrical power wires routed from the power fiber cable 500. The proximal end 302 may include labels 315, 317 to identify on the internal power connector 300 the positive and negative polarity terminals 314, 316, respectively. The proximal end 302 further includes screw terminals 330, 332 that each include a screw that can be turned in clockwise and counterclockwise directions by a screwdriver to tighten and untighten, respectively, the positive and negative polarity terminals 314, 316 onto the electrical power wires routed from the power fiber cable 500 to electrically connect the wires to the internal power connector 300.

In certain embodiments, the positive and negative polarity terminals 314, 316 operate at a nominal current of about 12 A, a rate voltage of about 250V, and are configured to receive electrical power wires having a diameter of about 24-12 American Wire Gauge (AWG).

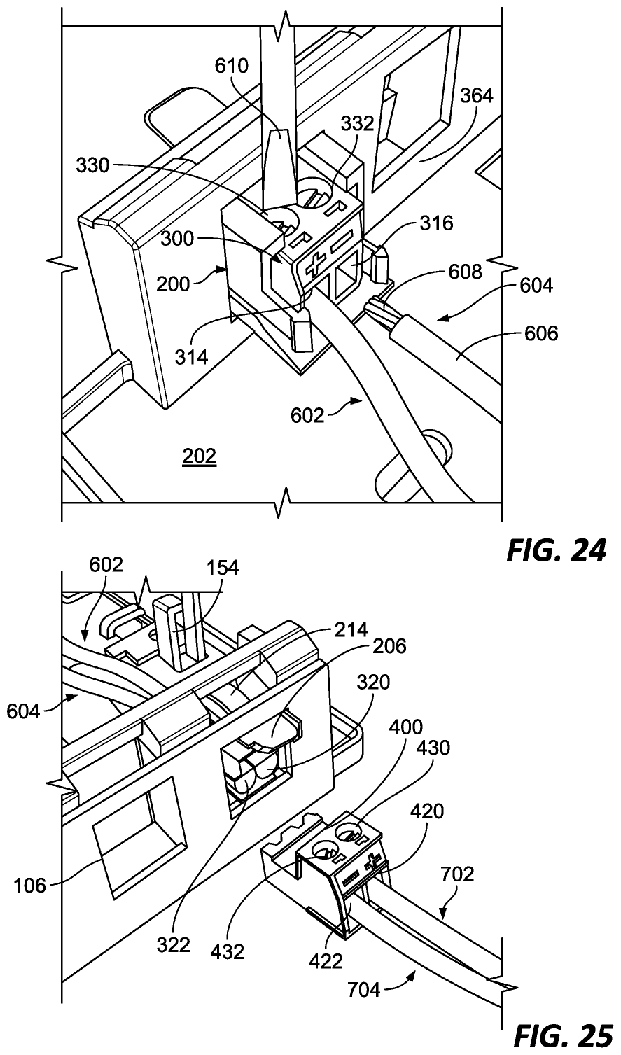

FIG. 24 shows assembly of electrical power wires 602, 604 routed from the power fiber cable 500 into the internal power connector 300. Referring now to FIGS. 14, 15, and 24, the electrical power wires 602, 604, are cut to an appropriate length, and an insulation layer 606 of the wires is stripped off using an electrical wire stripper (not shown). The exposed copper 608 of each electrical power wire 602, 604 is inserted into the positive and negative polarity terminals 314, 316 to match the polarity of the electrical power wires 602, 604 with the appropriate polarity terminals of the internal power connector 300. Thereafter, a screwdriver 610 is used to turn the screws inside the screw terminals 330, 332 to tighten the positive and negative polarity terminals 314, 316 around the exposed copper 608 of each electrical power wire 602, 604 to connect the internal power connector 300 to the electrical power wires 602, 604.

The illustrative embodiment depicted in FIG. 24 shows the internal power connector 300 already inserted in the power adapter 200, while the electrical power wires 602, 604 are being connected to the positive and negative polarity terminals 314, 316. In alternative embodiments, the electrical power wires 602, 604 can be first connected to the positive and negative polarity terminals 314, 316, and thereafter, the internal power connector 300 with the electrical power wires 602, 604 attached thereto can be inserted into the power adapter 200.

Referring now to FIGS. 14-16, the distal end 304 of the internal power connector 300 is structured for insertion into the interior side 202 of the power adapter 200, and for mating with a proximal end 402 of the external power connector 400 to provide an electrical connection between the external power connector 400 and the electrical power wires 602, 604.

FIG. 16 is an isometric view of the internal power connector 300 inserted into the power adapter 200. Referring now to FIGS. 12-16, the angled surfaces 234 of the latches 232 of the power adapter 200 are configured to slide along the opposite side surfaces of the internal power connector 300 such that the arms 230 extend outwardly to receive the internal power connector 300 until the internal power connector 300 is fully inserted into the power adapter 200 at which point the arms return to their rested position and the orthogonal surfaces 236 engage the proximal end 302 of the internal power connector 300. In certain examples, the internal power connector 300 snap-fits into the power adapter 200 without requiring the use of any tools.

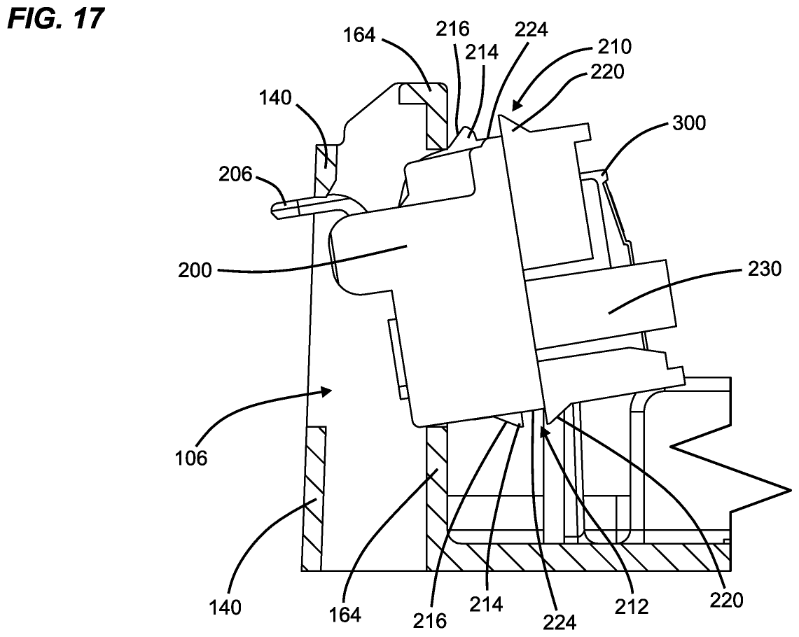

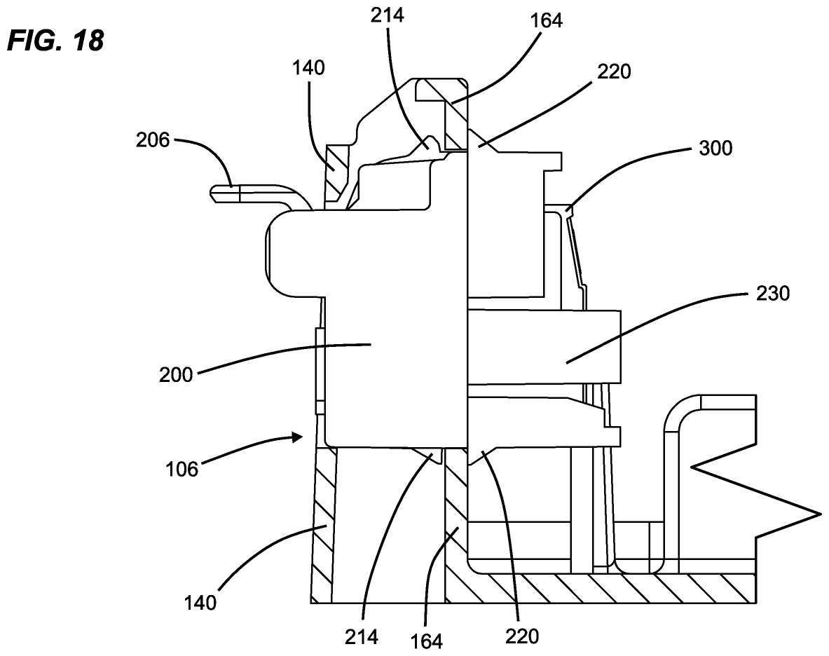

FIG. 17 is a cross-sectional view of the power adapter 200 and internal power connector 300 partially inserted into a port 106 of the surface mount module 100. FIG. 18 is a cross-sectional view of the power adapter 200 and internal power connector 300 fully inserted into the port 106 of the surface mount module 100. Referring now to FIGS. 17 and 18, the power adapter 200 is structured to be fixed to a port 106 of the surface mount module 100 without requiring the use of any tools. While the illustrative embodiment depicted in FIGS. 17 and 18 shows the power adapter 200 being inserted into the port 106 with the internal power connector 300 already inserted in the power adapter 200, in alternative examples, the power adapter 200 can be inserted into the port 106 without the internal power connector 300 already inserted therein, such that the internal power connector 300 can be inserted into the power adapter 200 after the power adapter 200 has already been inserted into the port 106.

Referring now to FIGS. 17 and 18, the power adapter 200 is inserted from the interior space 113 of the base 102 by aligning the power adapter 200 with an appropriate port of the base 102 while ensuring the terminal cover 206 of the power adapter 200 is facing upward.

As shown in FIG. 17, the power adapter 200 is inserted into the port 106 at an angle so that the terminal cover 206 can clear both the interior wall 164 and the exterior wall 140 of the base 102. The power adapter 200 is pushed through the interior wall 164 such that the groove 224 of the first set of catch features 210 engages a top portion of the interior wall 164 of the base 102 where the port 106 is located. The angled surface 216 and flexibility of the distal catch feature 214 helps the groove 224 capture the interior wall 164 by allowing the power adapter 200 to be positioned into the port 106 such that the interior wall 164 is caught by the groove 224. In certain examples, the connection between the groove 224 and the interior wall 164 is a snap-fit connection. The snap-fit connection allows the power adapter 200 to attach to the port 106 and to be removed from the port 106 without requiring the use of any tools.

Thereafter, the interior side 202 of the power adapter 200 is rotated downwards until the groove 224 of the second set of catch features 212 snaps into a bottom portion of the interior wall 164 of the base 102 where the port 106 is located. The angled surface 216 and flexibility of the distal catch feature 214 can help the groove 224 catch onto the bottom portion of the interior wall 164 such that the interior wall 164 is snap-fitted into the groove 224.

In embodiments where the surface mount module 100 includes two ports 106 that are dedicated for distributing electrical power, these steps can be repeated for installing a second power adapter. In embodiments where the surface mount module 100 includes only one port 106 dedicated for distributing electrical power, a blank insert 116 can be inserted into an unused port.

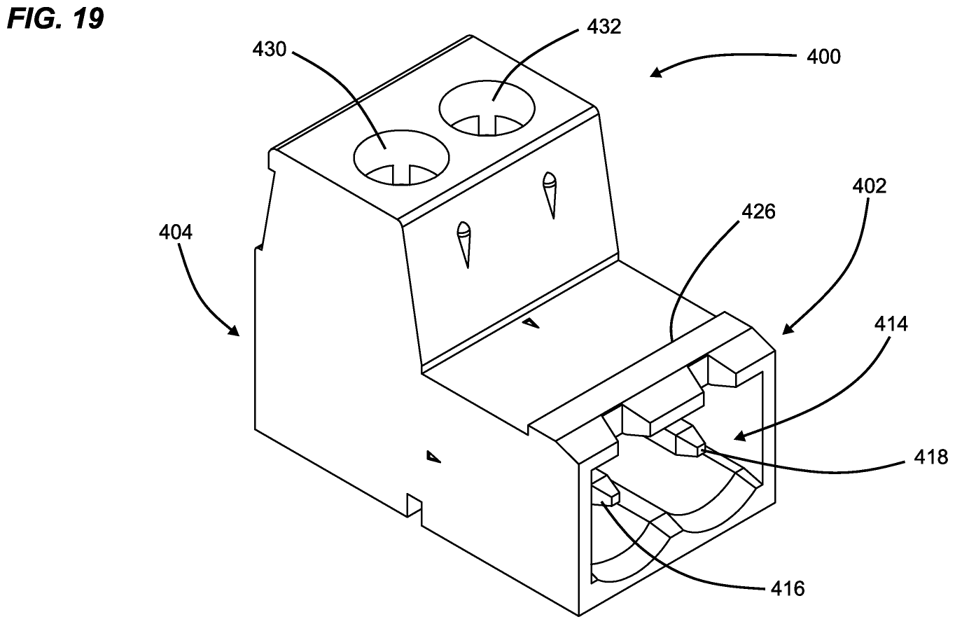

FIG. 19 is an isometric view of the external power connector 400. The external power connector 400 includes a proximal end 402 and a distal end 404. The proximal end 402 defines a cavity 414 such that when the external power connector 400 is inserted into the exterior side 204 of the power adapter 200 and the internal power connector 300 is inserted into the interior side 202 of the power adapter 200, the proximal end 402 of the external power connector 400 mates the distal end 304 of the internal power connector 300.

The proximal end 402 of the external power connector 400 at least partially surrounds the distal end 304 of the internal power connector 300 when both the internal power connector 300 and external power connector 400 are inserted into the power adapter 200. In certain examples, the distal end 304 of the internal power connector 300 is a male connector, and the proximal end 402 of the external power connector 400 is a female connector.

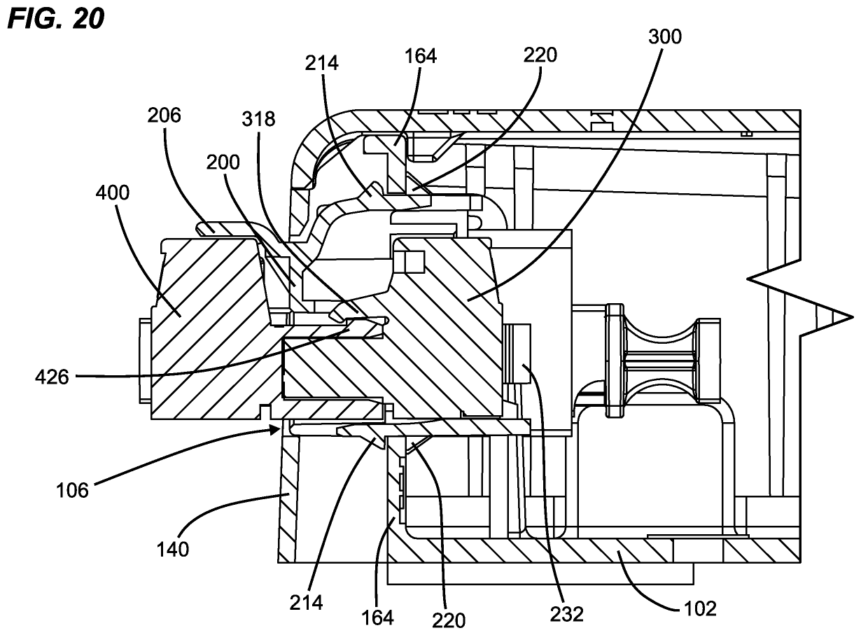

FIG. 20 is a cross-sectional view of the external power connector 400 inserted into the power adapter 200, the power adapter 200 inserted into a port 106 of the surface mount module 100, and the internal power connector 300 inserted into the power adapter 200. Referring now to FIGS. 14, 19, and 20, the latch 318 from the internal power connector 300 latches onto an orthogonal surface 426 on the proximal end 402 of the external power connector 400. Thus, the external power connector 400 snap-fits onto the internal power connector 300 when both connectors are inserted into the power adapter 200, and thereby forming a mechanical connection between the external power connector 400 and the internal power connector 300.

To remove the external power connector from the power adapter 200 and internal power connector 300, the latch 318 on the internal power connector 300 has an angle on a back side that causes the latch 318 to deflect when a withdrawal force is applied to the external power connector 400. A technician can apply the withdrawal force to the external power connector 400 by hand to overcome the mechanical connection provided from the latch 318. In some illustrative examples, the withdraw force is rated at approximately 12 N.

As shown in FIG. 21, the distal end 404 of the external power connector 400 includes positive and negative polarity terminals 420, 422 that each receive an electrical power wire routed from an external device such as a modem, router, cable television set-top box, and the like. The distal end 404 may include labels 421, 423 to identify the positive and negative polarity terminals 420, 422, respectively. The distal end 404 of the external power connector 400 further includes screw terminals 430, 432 that each have a screw that can be turned in clockwise and counterclockwise directions by the screwdriver 610 to tighten and untighten, respectively, the positive and negative polarity terminals 420, 422 onto electrical power wires to electrically connect the electrical power wires to the external power connector 400.

In certain embodiments, the positive and negative polarity terminals 420, 422 operate at a nominal current of about 12 A, a rate voltage of about 250V, and are configured to receive electrical power wires having a diameter of about 24-12 American Wire Gauge (AWG).

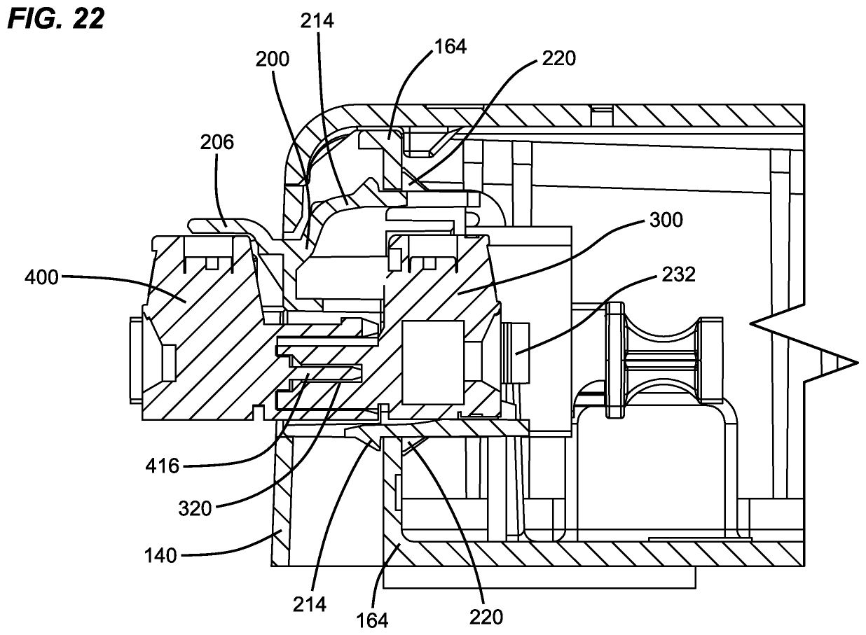

FIG. 22 is another cross-sectional view of the external power connector 400 inserted into the power adapter 200, the power adapter 200 inserted into a port 106 of the surface mount module 100, and the internal power connector 300 inserted into the power adapter 200. Referring now to FIGS. 14, 19 and 22, the external power connector 400 has prongs 416, 418 positioned inside the cavity 414. The prongs 416, 418 are insertable into corresponding receptacles 320, 322 inside the distal end 304 of the internal power connector 300. When the prongs 416, 418 are inserted into the receptacles 320, 322, an electrical connection is established between the external power connector 400 and the internal power connector 300.

FIG. 25 shows assembly of electrical power wires 702, 704 routed from an external device into the external power connector 400. Referring now to FIGS. 19, 22, and 25, the electrical power wires 702, 704, are cut to an appropriate length, and an insulation of the wires is stripped off using an electrical wire stripper (not shown). The exposed copper of each electrical power wire 702, 704 is inserted into the positive and negative polarity terminals 420, 422 to match the polarity of the wires from the external device with the appropriate polarity terminals of the external power connector 400. Thereafter, the screwdriver 610 is used to turn the screws inside the screw terminals 430, 432 to tighten the positive and negative polarity terminals 420, 422 around the exposed copper of each electrical power wire 702, 704 to connect the external power connector 400 to the electrical power wires 702, 704.

FIG. 21 is a top isometric view of a portion of the surface mount module 100 with the cover 104 removed therefrom, exposing the external power connector 400 inserted into the power adapter 200, the power adapter 200 inserted into a port 106 of the surface mount module 100, and the internal power connector 300 inserted into the power adapter 200. As shown in FIG. 21, the terminal cover 206 of the power adapter 200 advantageously covers the screw terminals 430, 432 of the external power connector 400. This can help prevent outside interference with the external power connector 400 after it has been installed in the surface mount module 100.

Referring now to FIG. 26, the power fiber cable 500 is shown broken out into optical fibers 502 and the electrical power wires 602, 604. At least some optical fibers 502 are terminated by fiber connectors 170 that are inserted into the fiber optic adapter 108, while at least one optical fiber 502 is stored in the interior space 113 of the surface mount module 100. The spiral wrap 119 is shown protecting the exposed portions of the optical fibers 502. Also, fiber connectors 172 are inserted into an opposite side of the fiber optic adapter 108 such that the fiber optic adapter 108 provides an optical connection between the fiber connectors 170, 172. In certain embodiments, the fiber connectors 170, 172 are LC connectors. At least some of the wire management devices 154 help guide and route the optical fibers 502 from the power fiber cable 500 inside the interior space 113 of the surface mount module 100 to prevent sharp turn radiuses.

As further shown in FIG. 26, the electrical power wires 602, 604 that break out from the power fiber cable 500 are terminated by the internal power connector 300 which is connected to the external power connector 400. The electrical power wire 702, 704 from the external device are terminated by the external power connector 400. At least some of the wire management devices 154 help guide and route the electrical power wires 602, 604 from the power fiber cable 500 inside the interior space 113 of the surface mount module 100.

FIGS. 27 and 28 are views showing removal of the power adapter 200 from a port 106 of the surface mount module 100. As shown in FIG. 27, the screwdriver 610 can be used to dislodge the groove 224 of the second set of catch features 212 from the bottom portion of the interior wall 164 of the port 106. As shown in FIG. 28, the screwdriver 610 can be used to actuate the distal catch feature 214 of the first set of catch features 210 to release the groove 224 from the top portion of the interior wall 164 where the port 106 is located. As described above, in certain embodiments, the distal catch feature 214 is a movable latch that can be actuated by the screwdriver 610 to flex inwardly to release the power adapter 200 from the port 106.

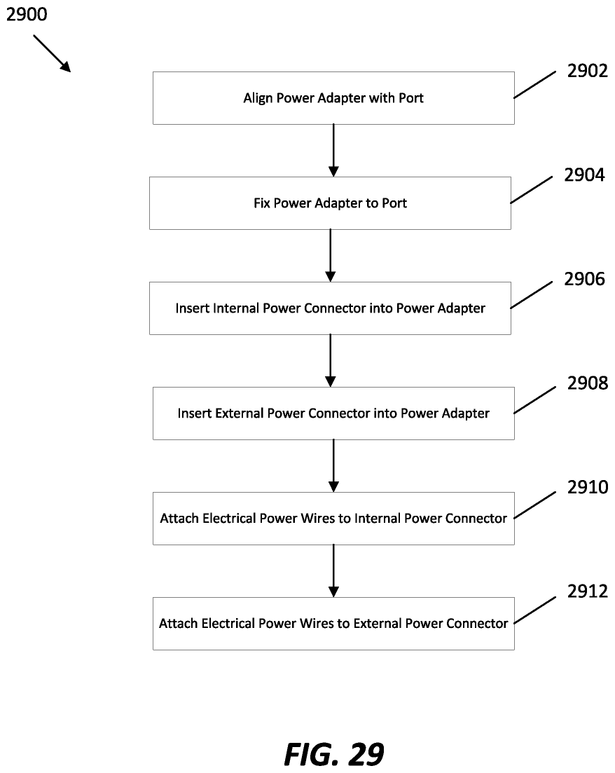

FIG. 29 illustrates a method 2900 of assembling a port for distributing electrical power from the surface mount module 100. As shown in FIG. 29, the method 2900 includes an operation 2902 of aligning the power adapter 200 with an appropriate port of the surface mount module 100. The power adapter 200 is aligned a port 106 inside the interior space 113. Next, the method 2900 includes an operation 2904 of fixing the power adapter 200 to the port 106.

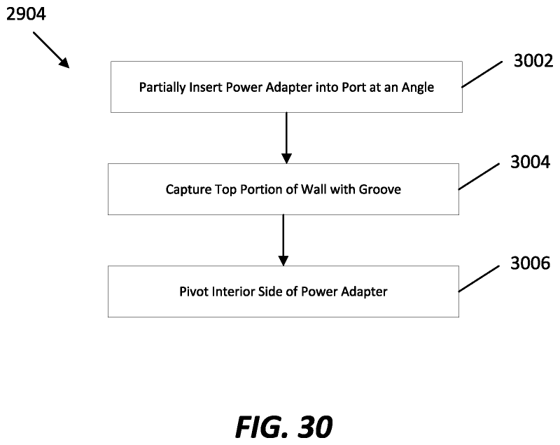

FIG. 30 illustrates operation 2904 in more detail which includes a sub-operation 3002 of partially inserting the power adapter 200 into the port 106 at an angle. Completion of sub-operation 3002 is shown in FIG. 17. Next, operation 2904 includes a sub-operation 3004 of capturing a top portion of the interior wall 164 where the port 106 is located into the groove 224 defined between the first set of catch features 210. Thereafter, operation 2904 includes a sub-operation 3006 of pivoting the interior side 202 of the power adapter 200 until the groove 224 defined between the second set of catch features 212 captures a bottom portion of the interior wall 164 where the port 106 is located. Completion of sub-operation 3006 is shown in FIG. 18. Advantageously, completion of operation 2904 allows the power adapter 200 to be fixed to the port 106 of the surface mount module 100 without requiring the use of any tools.

Returning back to FIG. 29, the method 2900 further includes an operation 2906 of inserting the internal power connector 300 into the interior side 202 of the power adapter 200. In some embodiments, the internal power connector 300 is inserted into the interior side 202 of the power adapter 200 before the power adapter 200 is fixed to the port 106 (i.e., operation 2906 is performed before operation 2904). In alternative examples, the internal power connector 300 is inserted into the interior side 202 of the power adapter 200 after the power adapter 200 is fixed to the port 106 (i.e., operation 2906 is performed after completion of operation 2904).

Thereafter, the method 2900 includes an operation 2908 of inserting the external power connector 400 into the exterior side 204 of the power adapter 200. As described above, when the external power connector 400 is inserted into the exterior side 204 of the power adapter 200, the latch 318 from the internal power connector 300 latches onto the orthogonal surface 426 of the external power connector 400 for providing a mechanical connection between the external power connector 400 and the internal power connector 300 while both are held by the power adapter 200. FIG. 20 shows a cross-sectional view after completion of operation 2908.

In certain embodiments, the method 2900 may include an optional operation 2910 of attaching the electrical power wires 602, 604 from the power fiber cable 500 to positive and negative polarity terminals 314, 316 of the internal power connector 300. In some embodiments, the electrical power wires 602, 604 from the power fiber cable 500 are attached to positive and negative polarity terminals 314, 316 of the internal power connector 300 before the internal power connector 300 is inserted into the power adapter 200 (i.e., operation 2910 is performed before operation 2906), or before the power adapter 200 is aligned and fixed to the port 106 (i.e., before operations 2902 and 2904). In alternative embodiments, the electrical power wires 602, 604 from the power fiber cable 500 are attached to positive and negative polarity terminals 314, 316 of the internal power connector 300 after the internal power connector 300 is inserted into the power adapter 200 (i.e., operation 2910 is performed after operation 2906).

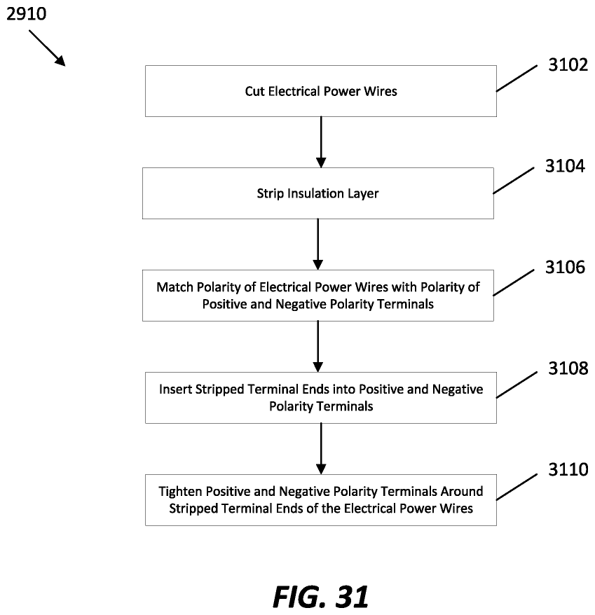

FIG. 31 shows operation 2910 in more detail which includes sub-operations 3102-3110. At least some of the sub-operations 3102-3110 are shown in FIG. 24. Referring now to FIGS. 24 and 31, a sub-operation 3102 of cutting the electrical power wires 602, 604 to an appropriate length; a sub-operation 3104 of stripping the insulation layer 606 from terminal ends of the electrical power wires 602, 604; a sub-operation 3106 of matching a polarity of the electrical power wires 602, 604 with the positive and negative polarity terminals 314, 316 of the internal power connector 300; a sub-operation 3108 of inserting the stripped terminal ends of the electrical power wires 602, 604 into the matched positive and negative polarity terminals 314, 316; and a sub-operation 3110 of using the screwdriver 610 to tighten the positive and negative polarity terminals 314, 316 around the terminal ends of the electrical power wires 602, 604.

Returning back to FIG. 29, the method 2900 may include an optional operation 2912 of attaching the electrical power wires 702, 704 from an external device to the positive and negative polarity terminals 420, 422 of the external power connector 400. Completion of operation 2912 may be substantially similar to operation 2910 described above.

In some embodiments, the electrical power wires 702, 704 from the external device are attached to positive and negative polarity terminals 420, 422 of the external power connector 400 before the external power connector 400 is inserted into the power adapter 200 (i.e., operation 2912 is performed before operation 2908), or before the power adapter 200 is aligned and fixed to the port 106 (i.e., before operations 2902 and 2904). In alternative embodiments, the electrical power wires 702, 704 from the external device are attached to positive and negative polarity terminals 420, 422 of the external power connector 400 after the external power connector 400 is inserted into the power adapter 200 (i.e., after operation 2908).

In certain examples, the method 2900 is repeated for assembling a second port for distributing electrical power from the surface mount module 100, as well as for installing more than two ports for distributing electrical power from the surface mount module 100.

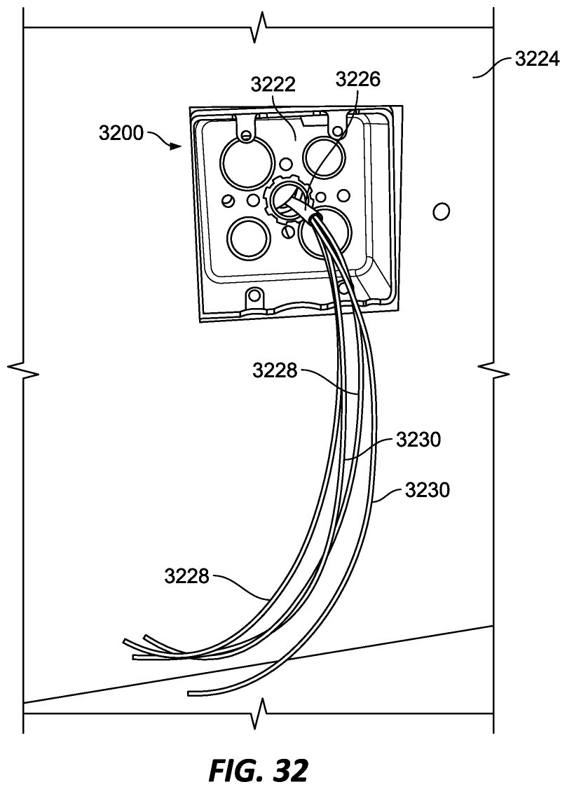

FIG. 32 shows an example location 3200 for mounting the surface mount module 100. The location 3200 includes an electrical box 3222 that is mounted to drywall 3224. In the example shown in FIG. 32, the electrical box 3222 is a 4 inch by 4 inch and 2⅛ inch deep double gang metal electrical box that is attached to a stud (not shown) and the drywall.

As further shown in FIG. 32, a hybrid power fiber cable 3226 extends through the electrical box 3222 from an interior side of the drywall to an exterior side of the drywall. The hybrid power fiber cable 3226 includes both electrical wires 3228 and optical fibers 3230 within a single cable for distributing both electrical power and fiber optic data connectivity.

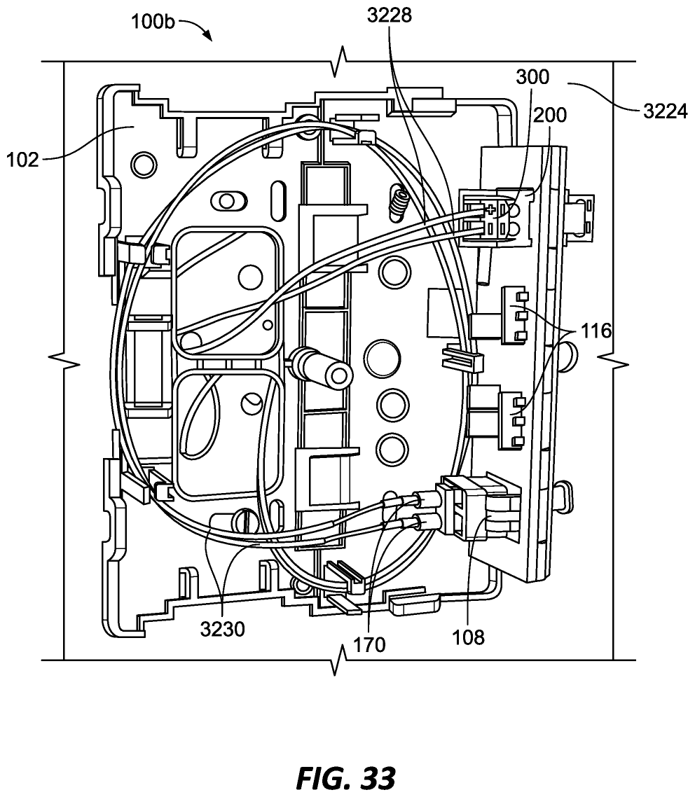

FIG. 33 shows an example of a base 102 of the embodiment of the surface mount module 100b (shown in FIG. 23) mounted to the location 3200. As described above, the self-tapping screws 144 can be used to fix the base 102 to the electrical box 3222. Additionally, the double-sided adhesive foam tape 146 can be used to fix the base 102 to the drywall 3224.

As shown in FIG. 33, one set of electrical wires 3228 from the hybrid power fiber cable 3226 are terminated by an internal power connector 300 that is mounted to a power adapter 200 that is inserted into a port 106 defined by the base 102, and the optical fibers 3230 from the hybrid power fiber cable 3226 are terminated by fiber connectors 170 that are inserted into a fiber optic adapter 108 that is inserted into a port 106 defined by the base 102. Two ports 106 of the surface mount module 100b are covered by the blank inserts 116 and are unused.

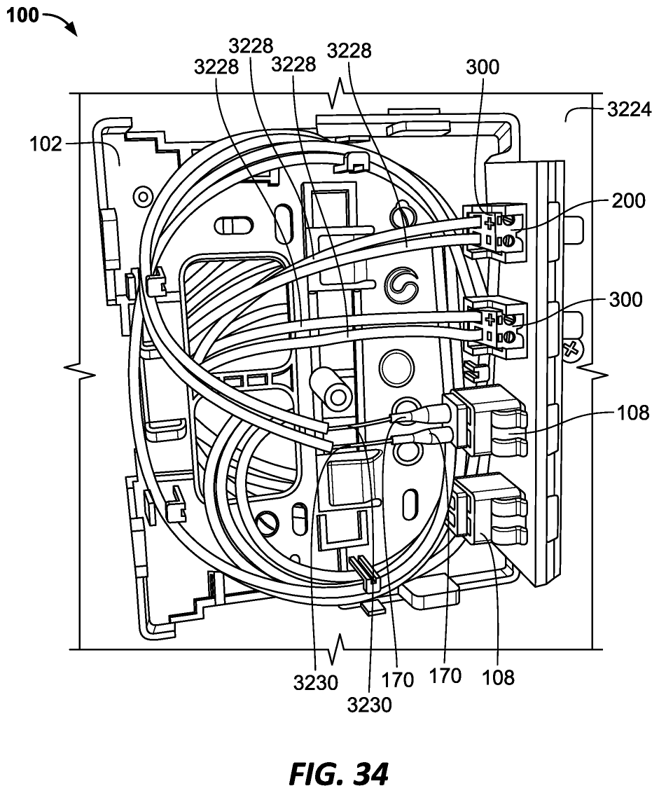

FIG. 34 shows another example of a base 102 of the surface mount module 100 shown in FIGS. 1-8 mounted to the location 3200. Two sets of electrical wires 3228 from the hybrid power fiber cable 3226 are terminated by internal power connectors 300 each mounted to a power adapter 200 inserted into a port 106 defined by the base 102, and the optical fibers 3230 from the hybrid power fiber cable 3226 are terminated by fiber connectors 170 that are inserted into a fiber optic adapter 108 that is inserted into a port 106 defined by the base 102, while another fiber optic adapter 108 that is inserted in another port 106 is unused.

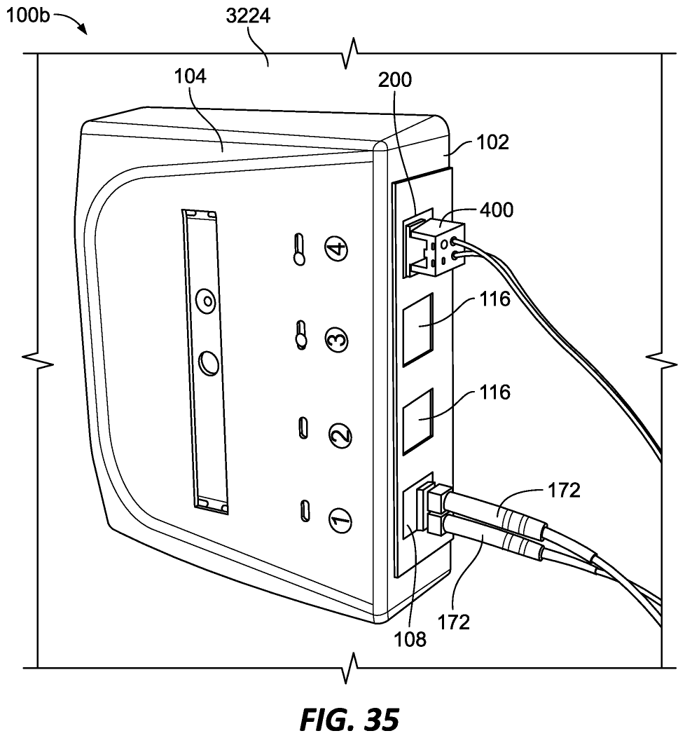

FIG. 35 shows the cover 104 attached to the base 102 of the surface mount module 100b of FIG. 33. As shown in FIG. 35, an external power connector 400 and fiber connectors 172 are installed in a power adapter 200 and a fiber optic adapter 108, respectively.

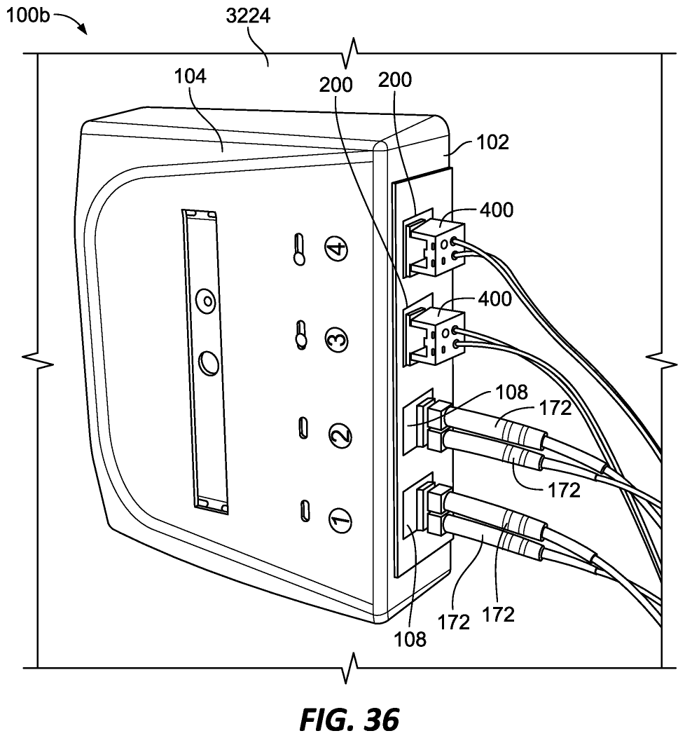

FIG. 36 shows the cover 104 attached to the base 102 of the surface mount module 100 of FIG. 34. As shown in FIG. 36, two external power connectors 400 and two sets of fiber connectors 172 are installed in respective power adapters 200 and fiber optic adapters 108.

The various embodiments described above are provided by way of illustration only and should not be construed to be limiting in any way. Various modifications can be made to the embodiments described above without departing from the true spirit and scope of the disclosure.

1. A surface mount module for distributing electrical power and fiber optic data connectivity from a power fiber cable, the surface mount module comprising:
a base having one or more features for attaching the surface mount module to a surface;
a cover attachable to the base to define an interior space inside the surface mount module, the interior space including one or more wire management devices for routing electrical power wires and optical fibers that break out from the power fiber cable;
at least one port configured to provide fiber optic data connectivity with the optical fibers that break out from the power fiber cable inside the interior space;
at least one port configured to distribute electrical power from the electrical power wires of the power fiber cable; and
a power adapter configured for fixation to the at least one port configured to distribute electrical power, and being further configured to receive an internal power connector at an interior side and to receive an external power connector at an exterior side.

2. The surface mount module of claim 1, wherein the power adapter includes a first set of catch features and a second set of catch features, the first and second sets of catch features being positioned on opposite sides of the power adapter, and each defining a groove that catches onto a wall that at least partially defines the at least one port configured to distribute electrical power.

3. The surface mount module of claim 2, wherein the first and second sets of catch features each include a movable latch that flexes enabling the groove to catch onto the wall.

4. The surface mount module of claim 1, wherein the power adapter includes a pair of arms extending outwardly from the interior side, each arm including a latch at a terminal end to fix the internal power connector to the power adapter.

5. The surface mount module of claim 1, wherein the power adapter includes a terminal cover extending outwardly from the exterior side, the terminal cover configured to cover screw terminals on the external power connector when the external power connector is inserted into the power adapter.

6. The surface mount module of claim 1, further comprising the internal power connector received at the interior side of the power adapter, and the external power connector received at the exterior side of the power adapter, wherein the external power connector includes prongs that are insertable into corresponding receptacles of the internal power connector for electrically connecting the external power connector to the internal power connector.

7. The surface mount module of claim 6, wherein the external power connector has a proximal end defining a cavity, the prongs being positioned inside the cavity, and wherein when the external power connector is inserted into the exterior side of the power adapter and the internal power connector is inserted into the interior side of the power adapter, the proximal end of the external power connector mates with a distal end of the internal power connector.

8. The surface mount module of claim 7, wherein the proximal end of the external power connector at least partially surrounds the distal end of the internal power connector when the internal power connector and the external power connector are inserted into the power adapter.

9. The surface mount module of claim 7, wherein the internal power connector includes a latch that extends toward the distal end of the internal power connector, the latch being configured to latch onto the proximal end of the external power connector providing a mechanical connection between the internal power connector and the external power connector when the internal power connector and the external power connector are inserted into the power adapter.

10. The surface mount module of claim 7, wherein the internal power connector has a proximal end that includes positive and negative polarity terminals configured to receive the electrical power wires routed from the power fiber cable, and the proximal end of the internal power connector further includes screw terminals that each include a screw configured to be turned in clockwise and counterclockwise directions to tighten and untighten, respectively, the positive and negative polarity terminals onto the electrical power wires from the power fiber cable.

11. The surface mount module of claim 7, wherein the external power connector has a distal end that includes positive and negative polarity terminals configured to receive electrical power wires routed from an external device, and the distal end of the external power connector further includes screw terminals that each include a screw configured to be turned in clockwise and counterclockwise directions to tighten and untighten, respectively, the positive and negative polarity terminals onto the electrical power wires from the external device.

12. The surface mount module of claim 7, comprising one port for distributing electrical power and one port for providing fiber optic data connectivity.

13. The surface mount module of claim 7, comprising two ports for distributing electrical power and two ports for providing fiber optic data connectivity.

14. A power adapter for a surface mount module, the power adapter comprising:
first and second sets of catch features positioned on opposite sides of the power adapter, each of the first and second sets of catch features including:
one or more distal catch features with angled surfaces;
one or more proximal catch features; and
a groove defined between the distal catch features and the proximal catch features, the groove configured to catch onto a wall that at least partially defines a port; and
flexible arms each having a latch at a terminal end, the latches being configured to fix an internal power connector to an interior side of the power adapter before the power adapter is installed into the port, or after the power adapter is installed into the port, and wherein the power adapter is structured to receive an external power connector at an exterior side.

15. The power adapter of claim 14, wherein the one or more distal catch features are movable latches that flex when the angled surfaces engage against the wall when the power adapter is pushed into the port to provide a snap-fit connection onto the wall.

16. The power adapter of claim 14, wherein the proximal catch features are fixed protrusions such that the wall remains captured by the groove unless the distal catch features are actuated to flex inwardly to release the power adapter from the wall.

17. The power adapter of claim 14, further comprising a terminal cover extending outwardly from the exterior side, the terminal cover configured to cover screw terminals on the external power connector when the external power connector is inserted into the power adapter.

18. The power adapter of claim 14, further comprising the internal power connector fixed to the interior side of the power adapter.

19. The power adapter of claim 14, further comprising the external power connector fixed to the exterior side of the power adapter.

20. A method of assembling a port for distributing electrical power from a surface mount module, the method comprising:
aligning a power adapter with an appropriate port of the surface mount module;
fixing the power adapter to the port by:
partially inserting the power adapter into the port at an angle;
capturing a top portion of a wall where the port is located into a groove defined between a first set of catch features; and
pivoting an interior side of the power adapter until a groove defined between a second set of catch features captures a bottom portion of the wall where the port is located; and
inserting an internal power connector into the interior side of the power adapter.

21-26. (canceled)

27. A surface mount module for distributing electrical power and fiber optic data connectivity, the surface mount module comprising:
a base having one or more features for attaching the surface mount module to a surface;
a cover attached to the base to define an interior space inside the surface mount module, the interior space including one or more wire management devices;
at least one port providing fiber optic data connectivity that includes a fiber optic adapter fixed thereto, and at least one fiber connector inserted into the fiber optic adapter, the at least one fiber connector terminating one or more optical fibers; and
at least one port configured to distribute electrical power that includes a power adapter fixed thereto, and an internal power connector inserted into an interior side of the power adapter, the internal power connector terminating electrical power wires.

28. The surface mount module of claim 27, further comprising an external power connector inserted into an exterior side of the power adapter, the external power connector terminating electrical power wires from an external device.

29. The surface mount module of claim 27, further comprising a hybrid power fiber cable that breaks out into the one or more optical fibers and the electrical power wires inside the interior space of the surface mount module.
